(19) United States
(12) Patent Application Publication
(10) Pub. No.: US 2009/0037043 A1
(43) Pub. Date: Feb. 5, 2009

(54) Visual Information Apparatus for Real-Time Demonstration of Braking Behaviour of Motorcycles

(76) Inventor: Sandor Konkolyi, Budapest (HU)

Correspondence Address: BIRCH STEWART KOLASCH & BIRCH, PO BOX 747, FALLS CHURCH, VA, 22040-0747, US

(21) Appl. No.: 12/278,138

(22) PCT Filed: Oct. 10, 2006
(86) PCT No.: PCT/HU2006/000090

§ 371 Date: Aug. 19, 2008

(30) Foreign Application Priority Data
Feb. 3, 2006 (HU) P0600087
Jul. 3, 2006 (HU) P0600556

(51) Int. Cl. G06F 7/00

(52) U.S. Cl. 701/29

(57) ABSTRACT

Visual information apparatus for real-time demonstration of braking behaviour of a motorcycle, the motorcycle is provided with elastically suspended front wheel and rear wheel (3,4), independently operable front wheel brake and independently operable rear wheel brake and a visual display device (7). The apparatus is provided with sensors (5,6) adapted to measure directly or indirectly the momentary forces acting on said elastic suspensions (1,2) of the front wheel and rear wheel (3,4) respectively, or to measure indirectly the ratio of said forces; a calculating means adapted to calculate from the signals of said sensors (5,6) the ratio of said momentary forces acting on said suspensions (1,2) of said front and rear wheel (3,4) and to calculate the difference between said ratio and a given value. The visual display device (7) is adapted to display the deviation.

The present invention relates to a visual information apparatus for real-time demonstration of braking behaviour of a motorcycle, the motorcycle is provided with elastically suspended front wheel and rear wheel, independently operable front wheel brake and independently operable rear wheel brake and a visual display device.

When driving a motorcycle proper and synchronized control of the brakes (front brake and rear brake operated independently of each other by means of a brake lever and/or brake pedal) and the driving force applied to the rear wheel (throttle lever) is very important. Otherwise the motorcycle might overturn either in the forward direction or backward direction which might be fatal to the driver.

In order to make the behaviour of a running motorcycle controllable on the basis of measuring parameters during its running state several attempts have been made. Patent application FR2720992 (Honda Motor Co. Ltd.) describes a brake system for motorcycles. The system consists of brake levers connected to the front and rear brakes by mechanical operating cables transmitting force to the front wheel brake and the rear wheel brake. A locking mechanism intercepts the force transmitted and when the brake force on one of the wheels exceeds a certain level the locking mechanism blocks or increases the mechanical force transmitted to the other wheel.

The object of U.S. Pat. No. 6,409,285 (also owned by Honda Motor Co. Ltd.) is to provide a front wheel and rear wheel interlocking brake system having a simple structure, which is capable of automatically performing brake control of the front and rear wheels on the basis of the running state of the motorcycle. The brake system includes a front wheel side actuator and a rear wheel side actuator for applying pressure to the respective wheel brake. At least one operating member is operated by a driver. An operated amount detecting member is provided for detecting the operated amounts of each brake operating member. A control member is provided for receiving and calculating each of operated amounts detected and outputting drive control signals on the basis of the calculated result. The control member performs brake control in accordance with specific braking force distribution characteristics (FIGS. 4, 6-8) which were fined probably on the basis of practical experiences, tests.

Both solutions imply automatic intervention and do not count on the driver. This, however, demands numbersome technical measures to be taken during manufacture which are necessary for appropriate modification of the structure. It is expensive and only the manufacturer is able to perform it safely. Disassembly and subsequent conversion of motorcycles is difficult and hazardous especially when the braking system is concerned.

The object of the present invention is to provide a solution by which disassembly of the braking system can be omitted and there is no need for intervention in the control system of the brakes.

Another object is to provide information to the driver on the basis of which the driver is able to make a decision as a result of which the amount or the ratio of the braking force applied to the front wheel brake and rear wheel brake can be influenced.

A further object is to support learning to drive a motorcycle by providing a device by means of which the driver's skill can be improved.

To achieve the above objects there is provided an apparatus having sensors adapted to measure directly or indirectly the momentary forces acting on the elastic suspensions of the front wheel and rear wheel respectively, or to measure indirectly the ratio of these forces; a calculating means adapted to calculate from the signals of the sensors the ratio of the momentary forces acting on the suspensions of the front wheel and rear wheel and to calculate the difference between this ratio and a given value. The visual display device is adapted to display the deviation.

In one embodiment the apparatus of the invention is provided with a decelerometer means adapted to detect deceleration in the running direction of the motorcycle or acceleration in the opposite direction; and a calculating means adapted to calculate from the output signal of the decelometer means the ratio of the momentary forces acting between the front and rear wheel and the ground and to calculate the difference between said ratio and a given value.

Preferably, the display means of the visual display device is symmetric and the extent of deviation from the given or ideal ratio is displayed linearly. The display device may be realized in the form of an indicator with a pointer or a screen. For example, the diagram of braking may be displayed on the screen which can be used for subsequent evaluation. The given value may be a calculated value or a value based on experiments, tests, for example under certain load, in state of rest or running state. To this end the apparatus may be provided with means for setting a basic value, for example a push-button which activates measurement and calculation needed for determining the given value serving as the base of comparison.

The apparatus may be used for training purposes, not only with real motorcycles but also with stationary simulators or special training-machines.

Details of the present invention will now be disclosed with reference to the accompanying drawings showing exemplary embodiments.

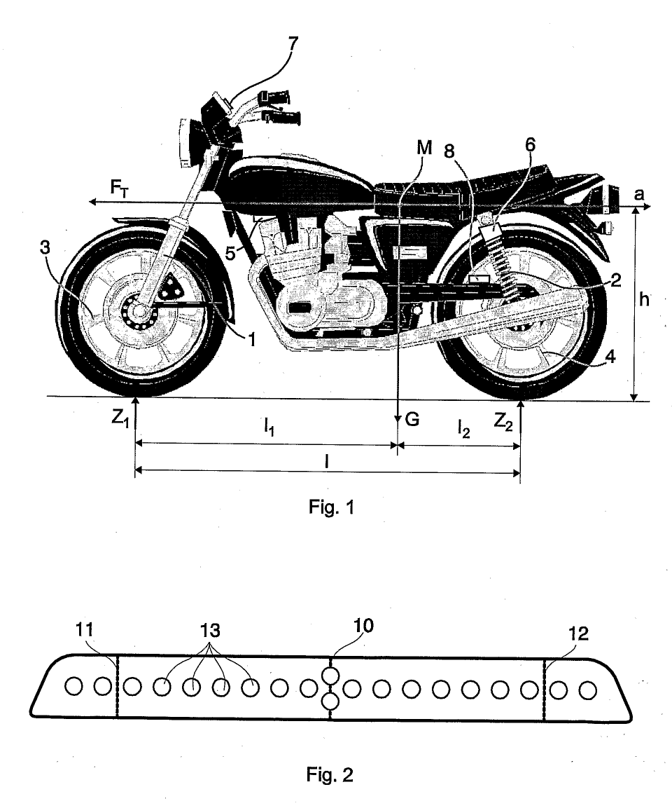

FIG. 1 is a schematic drawing of a motorcycle provided with the apparatus according to the invention.

FIG. 2 shows an exemplary embodiment of the visual display device according to the invention.

FIG. 1 is a schematic drawing of a motorcycle having a front wheel 3 and a rear wheel 4 mounted to the body of the motorcycle through elastic suspension 1,2. The wheels 3, 4 can be braked independently of each other in the customery manner by means of a brake lever and/or brake pedal. By this, the braking force can be applied to the front wheel 3 and rear wheel 4 separately. If the braking force applied to the front wheel 3 considerably exceeds the braking force applied to the rear wheel 4 the motorcycle might overturn. To be more exact, if the braking force applied to the front wheel reaches a certain level, when the force of weight and the cumulated resultant vector of the inertial force resulting from deceleration (acceleration) intersects the horizontal line correspondent to the ground at a point being out of the section determined by the contact points of the wheels and the ground, then the centre of gravity turns round the front wheel 3 (or rear wheel 4), i.e. the motorcycle overturns in the forward (or backward) direction.

Inversely, it might happen that the motorcycle overturns in the backward direction for example if the driver suddenly gives full throttle, the non-driven front wheel 3 will move away from the ground and the vehicle may overturn in the backward direction. In order to avoid these situations the purpose of the arrangement according to the present invention is to make the degree of danger visible, perceptible during training or real vehicular traffic. To this end the force applied to the rear wheel 4 and front wheel 3 as well as the ratio of these forces must be determined. In the state of rest the ratio of these two forces of weight is given in accordance with the mass distribution.

Forces can be measured directly or indirectly. When measurement is performed directly a suitable sensor should be installed in the suspension structure of the respective wheel. This sensor would measure the compressing force applied to the elastic suspension, i.e. the pressure exerted on the ground by the wheels. This solution may involve a number of technical difficulties. It is preferable to use the indirect method. This latter case is examined theoretically with reference to FIG. 1.

The wheels 3,4 respectively bear the weight of the motorcycle depending on the geometrical position of the centre of gravity, in accordance with the static wheel-load. This is modified by the inertial force during acceleration and deceleration. It is called dynamic wheel-load. The forces acting on the motorcycle when the brake is operated are shown in FIG. 1. The following are supposed for determination of them:
the braking effect is instantaneous, the braking force guaranteed by adhesion is maximal;
the brake is operated on a slippery road
air resistance, friction resistance, rolling resistance and the effect of rotating mass are negligible.

Forces shown in FIG. 1 are the following:

F_{T} is the inertial force;

G is the force of weight resulting from the mass of the motorcycle; and

Z₁ and Z₂ are the forces developing at the meeting points of the wheels and the ground (contact points).

By applying the equation of moment in the state of equilibrium to the contact point of one of the wheels 3, 4, the dynamic wheel load forces of the motorcycle, i.e. the equations determining forces Z₁ and Z₂ can be obtained.

$${Z}_{1} = G \times \frac{{l}_{2}}{l} + \frac{{F}_{T} \times h}{l}$$

$${Z}_{2} = G \times \frac{{l}_{1}}{l} + \frac{{F}_{T} \times h}{l}$$

Considering that

$${F}_{T} = \frac{G}{g} \times a$$

In which:

g is the gravitational acceleration;

a is the deceleration of the motorcycle;

l is the axle base;

l₁ is the first portion of the axle base;

l₂ is the second portion of the axle base; and

h is the height of the centre of gravity

Axle base l is the distance between the contact points of the two wheels 3,4. By vertically projecting the centre of gravity M onto the axle base it is divided into a first portion l₁ and a second portion l₂. Naturally, the centre of gravity M is determined in relation to a motorcycle under workload. Forces Z₁ and Z₂ developing between wheels 3,4 and the ground can be determined by the following formula:

$${Z}_{1} = \frac{G}{l} \times ( {l}_{2} + \frac{a}{g} \times h )$$

$${Z}_{2} = \frac{G}{l} \times ( {l}_{1} + \frac{a}{g} \times h )$$

It can be seen from the equations that the moment of inertia brings about a significant change in wheel-load during braking. The load on front wheel 3 increases while the load on rear wheel 4 decreases, in extreme cases it is reduced to zero. When determining Z₁/Z₂, in order to avoid dividing by zero when the ratio is calculated, a constant additive member can be used. There is no need for use of this additive member when Z₂/Z₁ is calculated because prior to turnover Z₁ can not be zero.

Because of the changes in dynamic wheel-load the motorcycle tilts in the forward direction, at this time the spring of the elastic suspension of the front wheel is compressed while the load on the spring of the elastic suspension of the rear wheel is reduced to zero. Compression of the springs is proportional to the load applied to them. The correlation between the most important features of a spring is determined by the characteristic of the spring which is constant in time in case of a given spring, i.e. in case of a certain amount of load the spring will always be compressed to the same extent.

It follows from the foregoing that in case of a given motorcycle forces Z₁ and Z₂ developing at the contact points of the wheels can be defined on the basis of the movement of the spring members, consequently the inertial force, deceleration of the motorcycle can be determined. Inversely, when a is known, then the movement of the spring members can be defined.

This is taken as the basis of the present invention. Accordingly, the deceleration a of the motorcycle is measured by means of a decelerometer, and depending on the result of this measurement, forces acting between the wheels 3,4 and the ground, i.e. Z₁ and Z₂ are determined.

The decelerometer for measuring deceleration a can be a sensor 5 (FIG. 1) which is available on the market. This sensor may for example output a substantially linear signal which is proportionate to the extent of spring compression induced by the inertial mass. This output signal, for example voltage, is proportionate to the degree of deceleration. By suitable calibration the so obtained linear signal can be used for determining the ratio of Z₁ and Z₂ values. The deviation of this ratio from a given value is calculated and displayed. The given value can be for example the ratio of the respective forces determined in the state of rest (under load). Experience shows that this ratio is nearly the same with motorcycles of different types having different load. This makes it easier to take the given value into account even in case of an all-purpose apparatus according to the invention. Calibration of the apparatus can be fined with respect to type and varying load conditions. When the ratio calculated on the basis of the output signal of sensor 5 exceeds a given threshold, a signal may be given to the driver. The given threshold may be determined on the basis of experiences or calculation. Since speed is not considered in the above equations, when braking is effected at low speed the same threshold can be used for pre-signalling that the rear wheel 4 moves away from the ground. An experienced driver is able to decide the safe limit beyond which the dangerous “lift-off” may occur.

Basically, sensor 5 for measuring deceleration may be mounted on an optional part of the motorcycle. Preferably, it is positioned at a place near the evaluation unit, which determines the values and the ratio of forces Z₁ and Z₂. Since this component part measures the deceleration vector component in the horizontal direction, this must be taken into account and it must be fixed in the proper direction. Advantageously, sensor 5 is placed so that it is protected from external effects.

An evaluation unit (not shown in FIG. 1) is added to the signal correspondent to deceleration. This evaluation unit provides a drive signal to the visual display device 7. Further, the evaluation unit calculates values Z₁, Z₂, Z₁/Z₂ according to the formulas described earlier. To this it can be provided with a microprocessor or a simple circuit adapted to perform electronic calculations.

To display the threshold values the drive signal of the evaluation unit which actuates the visual display device 7 must be assigned to the threshold values so that the visual warning information can be displayed before the rear wheel 4 moves away from the ground. Advantageously, the threshold value can be adjusted for example by means of an adjusting knob or any other suitable means.

An evaluation means adapted to measure the deceleration through the changes in speed (revolution) can also be mounted on one of the wheels, preferably on the front wheel 3 of the motorcycle. However, in case of a simple design for example which is adapted to measure the time of a complete revolution and count these revolutions, measuring of deceleration is less reliable than in case of a separately placed sensor. It is more accurate if the angle change is measured at several points during a revolution. In this case the speed of rotation is known from the degree of the angle change of the mechanical or inductive sensor means relative to a given point on the wheel. In the simplest case it is a complete revolution. This, however, results in that information can be obtained only after a complete or a certain partial revolution. This would render only delayed evaluation possible. If the angle change is measured at several points of number n per revolution, the delay time will be the time needed for the wheel to travel a distance corresponding to the n-th part of the wheel's perimeter. In order to display the danger of an immediate rise of rear wheel 4 and the motorcycle's turnover in time and with high accuracy, this solution works satisfactorily if n>1. With this solution a further embodiment may be accomplished, wherein measuring of speed is derived from the number of revolutions. The value of deceleration is calculated from the change in the revolution number.

This arrangement can be used as means for measuring the braking distance during braking and displaying it on visual display device 7. To this a sensor coupled to either front wheel 3 or rear wheel 4 for counting the revolutions can be used. If this sensor is coupled to the driven rear wheel 4 it may be installed in the driving chain, the main point is that it must be able to count the revolutions e.g. during braking. According to this embodiment the decelerometer means is a revolution counter means coupled to the front wheel 3 or rear wheel 4 or gearbox or driving chain of the motorcycle. Deceleration (acceleration) can be calculated from the time changes in the peripheral speed of the relative wheel by means of a calculating means. This calculating means must be added to the revolution counter means.

Induction-coupled means for counting the revolutions also can be used.

Further, it is possible to use two decelerometers of different types with the same motorcycle. In this manner a single motorcycle may be provided with both sensor 5 and revolution counter means.

An additional sensor 6 may be used for sensing the lift-off of the rear wheel 4. This can be a force-meter which—in addition to performing the calculations mentioned before in order to give notice of the impending lift-off—is adapted to sense the actual moment of lift-off if it should happen. By measuring deceleration a the event when the wheel's lift-off is not caused by travelling on a rough ground surface but because of braking, can be filtered out. Sensor 6 may be installed for example in the support of the suspension spring or somewhere else where it does not disturb the functioning of the elastic suspension system 2. If wheel 4 rises off the ground the value of this force will be zero. In a particular case sensor 6 may be a decelerometer or an accelerometer which detects the lift-off on the basis of acceleration in the vertical direction. The aforementioned momentary forces may be measured directly or indirectly. In case of direct measurement (which may correspond to the arrangement shown in FIG. 1 without sensor 5) a sensor 6 is installed in the elastic suspension 2 of wheel 4. This sensor 6 measures the compressing force applied to the spring. Sensor 6 may be installed for example in the support of the suspension spring or somewhere else where it does not disturb the functioning of the elastic suspension system 2. It is to be noted that a similar means may be used with front wheel 3 (this is not shown in the Figures). If wheel 4 rises off the ground the value of this force will be zero. To avoid dividing by zero when the ratio is calculated, this value can be increased by a constant additive member. The same is true for the force measured and calculated for the other wheel.

Force may also be measured indirectly (without measuring deceleration and calculating ratio). The basis of this measurement is that the elastic suspension 1 moves against the spring force relative to the members fixedly mounted on the motorcycle's body. Accordingly, wheel 3 or the axle of wheel 3 can move along a given straight line. The extent of displacement corresponds to the spring force of elastic suspension 1. In this manner force measurement is derived from distance measurement. Distance measurement can be carried out by using any known sensor means e.g. magnetic, optical or induction means.

In this manner sensors 5, 6 directly or indirectly provide an output signal proportionate to the amount of force applied to wheels 3,4. These signals are used for calculating the ratio of the momentary forces acting on the respective suspensions 1, 2 of front wheel 3 and rear wheel 4 and the difference between this ratio and a given value is observed continuously. To this a suitable calculating means is used for example a simple analogue or digital circuit. The output signal of the calculating means is transmitted to a visual display device 7 which is adapted to display the deviation.

The given value or basic value can be the ratio of the forces acting on respective suspensions 1 and 2 of front wheel 3 and rear wheel 4 in the state of rest. This value as well as the ratio calculated from the output signal of the sensors is a non-dimensional ratio. The apparatus according to the invention is designed for displaying the difference between these non-dimensional values. In an advantageous embodiment the difference is displayed along a line the central point of which denotes the state of rest, i.e. when the difference is zero. Negative and positive deviations from this value can be displayed along the line in two different directions. Such display device can be seen in FIG. 2. Here, the display device comprises LED means 13 arranged in a line. When the ratio of forces acting on the front wheel and rear wheel equals to the ratio calculated in the state of rest, the LED in the centre line 10 is lighted. In the embodiment shown in FIG. 2 in order to make it more perceptible two LEDs one above the other are positioned in the centre line 10. In the event that the danger of turnover exists the force applied to the rear wheel 4 significantly decreases relative to the force applied to the front wheel 3. In this case a LED 13 or several LEDs 13 in the respective direction along the line start flashing in this manner the driver of the motorcycle is informed of the danger. The critical values can be marked by lines 11 and 12 (safe limits) and/or by changing the colour and/or the light intensity of the LEDs. The safe limits may be determined depending on the type of the motorcycle.

A display device of another type, for example a conventional indicator means having a pointer may also be used as visual display device 7 for displaying deviations. The indicator may have a real pointer or an optical representation of the same. In this case a screen may be used as visual display device 7. The advantage of using a screen is that in addition to displaying the pointer of the indicator, other symbols visualizing the deviation may also be displayed in order to warn the driver. A diagram may be displayed which shows the duration of acceleration or deceleration in addition to showing the deviation from the given value. Further, alphanumeric display of the length of brake path is also possible. This additional information may be instrumental in learning to drive a motorcycle. A further possibility is to give an acoustic signal for example when the given threshold is reached. The intensity or other characteristic feature of the acoustic signal may depend on the extent of deviation.

With any of the aforementioned display device it is preferable to display the positive and negative values of deviation in two directions (symmetrically). It is shown in FIG. 2.

The main object of the apparatus according to the invention is to provide appreciable information for the learners or the drivers of the motorcycle which can be compared to their own experiences in order to make use of it during learning or in traffic. To this, the condition of activating the display may be that either the front wheel brake or the rear wheel brake is being operated. However, a solution is feasible that some sort of signal is displayed on the visual display device without operating the brake, but this does not deviate from the centre position.

The given value referred to above (the number used for comparing the ratio of the momentary forces acting on wheels 3 and 4) may be determined by means of sensors 5, 6 at a selected point of time in a desired state. (E.g. The weight distribution between the front wheel 3 and rear wheel 4 depends on whether only a driver rides on a driver's seat or a passenger also rides on a pillion.) The apparatus may be provided with means for setting a basic value, for example a push-button which activates measurement and calculation needed for determining the given value. This may be done either in the state of rest or running state. When the push-button is operated, the apparatus according to the invention measures the forces applied to wheels 3,4, calculates the ratio of them (by adding a constant in advance if needed) and this basic value will serve as the basis of comparison during display. The given value remains unchanged until a new basic value is set. The push-button (means for setting the basic value) may be mounted on an optional part of the motorcycle where it can be controlled easily.

Further, it is possible for the display device to display other information relating to travel, e.g. brake path, acceleration, speed, etc. Further, the display device 7 may be adapted to real-time display of the current optimal brake path associated with the actual speed. Optimal brake path means the shortest brake path needed for stopping the motorcycle in case of evenly applied brake force so that it does not result in turnover. In another case, when the purpose is to promote learning to drive a motorcycle the braking distance can be displayed on the basis of a limit value set differently from the ideal one.

In certain situations during travel the force applied to the wheels may vary significantly for a short time due to the road conditions for example. Advantageously, the signal of the sensor is transmitted through a filter which filters out the changes which are of shorter duration than a given threshold value, and makes the output signal more even. This given threshold value may be approximately 0-1 sec. Advantageously, this threshold value can be altered by setting the parameters of the filter. In this manner the apparatus works properly under different road conditions.

Each of the foregoing embodiments of the apparatus according to the invention relates to a real motorcycle running on a real road. However, there are cases when simulation of the effect of operating the brakes is wished especially for the purpose of teaching. To this end the apparatus may have a mode of operation in which the output signals of the sensors are simulated. A signal proportionate to the amount of force applied by operating the brake lever or brake pedal may be produced. In this manner the degree of danger can be displayed even in case of a fixed (not moving) motorcycle, there is no risk involved. An apparatus of this kind can be adapted to a real motorcycle e.g. so that when it is switched to simulation mode of operation the running situations mentioned earlier can be established even if the motorcycle moves slowly or not at all. On the other hand, it is possible to construct specific body frames for simulation purposes which can be used for practising the use of the brakes. Naturally, in this case further signalling elements must be added to the simulator, e.g. speedometer.

1-17. (canceled)

18. Visual information apparatus for real-time demonstration of braking behaviour of a motorcycle, the motorcycle is provided with elastically suspended front wheel and rear wheel (3,4), independently operable front wheel brake and independently operable rear wheel brake and a visual display device (7) said apparatus is provided with sensors (5,6) adapted to measure directly or indirectly the momentary forces acting on said elastic suspensions (1,2) of the front wheel and rear wheel (3,4) respectively, or to measure indirectly the ratio of said momentary forces; characterized in that a calculating means adapted to calculate from the signals of said sensors (5,6) the ratio of said momentary forces acting on said suspensions (1,2) of said front and rear wheel (3,4) and to calculate the difference between said ratio and a given value; the visual display device (7) is adapted to real-time display of said deviation and the current optimal brake path associated with the actual speed.

19. Visual information apparatus according to claim 18 characterized in that for indirect measurement of said forces said apparatus is provided with a decelerometer means adapted to detect deceleration (a) in the substantially horizontal running direction of the motorcycle or acceleration in the opposite direction; and a calculating means adapted to calculate from the output signal of said decelometer means the ratio of the momentary forces (Z₁,Z₂) acting between said front and rear wheel (3,4) and the ground and to calculate the difference between said ratio and a given value; and said visual display device (7) is adapted to display the deviation.

20. Visual information apparatus according to claim 18 characterized in that said decelerometer means is a sensor (5) applicable to measure deceleration.

21. Visual information apparatus according to claim 18 characterized in that said given value is the ratio of forces acting on said elastic suspensions (1,2) of said front wheel and rear wheel (3,4) in the state of rest.

22. Visual information apparatus according to claim 18 characterized in that said visual display device (7) is adapted to display the positive and negative values of deviation by displaying flash signals in two directions.

23. Visual information apparatus according to claim 22 characterized in that said visual display device (7) contains LED means (13) arranged in a line.

24. Visual information apparatus according to claim 22 characterized in that said visual display device (7) is an indicator means having a pointer.

25. Visual information apparatus according to claim 22 characterized in that said visual display device (7) is a screen.

26. Visual information apparatus according to claim 18 characterized in that said visual display device (7) is active only when one of the brakes is operated.

27. Visual information apparatus according to claim 18 characterized in that it is provided with means applicable to give acoustic signals depending on the value of said difference.

28. Visual information apparatus according to claim 18 characterized in that it has a mode of operation for simulating the signal of said sensor (5).

29. Visual information apparatus according to claim 18 characterized in that said given value is the ratio of the forces acting on said elastic suspensions (1,2) of said front wheel and rear wheel (3,4) measured under a given load distribution at a selected point of time.

30. Visual information apparatus according to claim 18 characterized in that the signal of said sensor (5,6) is transmitted through a filter adapted to average the changes which are of shorter duration than a given threshold value.

31. Visual information apparatus according to claim 30 characterized in that said given threshold value can be set optionally, e.g. 0.1 sec.

32. Visual information apparatus according to claim 29 characterized in that for determination of said given value the apparatus is further provided with means for setting a basic value which is adapted to activate the measurement with said sensors (5,6) and the calculation of said given value with said calculating means at said selected point of time.

33. Visual information apparatus according to claim 18 characterized in that said decelerometer means is a revolution counter means coupled to said front wheel (3) or rear wheel (4) or gearbox or driving chain of the motorcycle and it is provided with an additional calculating means for calculating the time changes in the peripheral speed of the relative wheel.

34. Visual information apparatus according to claim 18 characterized in that it is provided with sensors (5,6) adapted to measure indirectly the momentary forces acting on said elastic suspensions (1,2) of the front wheel and/or rear wheel (3,4) on the basis of the position of the respective wheel (3,4).
